(19) United States
(12) Patent Application Publication
(10) Pub. No.: US 2022/0415062 A1
(43) Pub. Date: Dec. 29, 2022

(54) METHOD FOR IDENTIFYING INDUSTRIAL CABLES

(71) Applicant: HARTING ELECTRIC STIFTUNG & CO. KG, Espelkamp (DE)

(72) Inventors: Felix LOSKE, Espelkamp (DE); Oliver BEYER, Espelkamp (DE)

(21) Appl. No.: 17/781,284

(22) PCT Filed: Nov. 25, 2020
(86) PCT No.: PCT/DE2020/100999

§ 371 Date: May 31, 2022

(30) Foreign Application Priority Data
Dec. 5, 2019 (DE) 10 2019 133 193.5

(51) Int. Cl. G06V 20/60; G06V 10/764; G06V 10/44; G06T 7/60; G06Q 30/06

(52) U.S. Cl. CPC G06V 20/60; G06V 10/764; G06V 10/44; G06T 7/60; G06Q 30/0627

(57) ABSTRACT

In order for a supplier of industrial cables to reduce personnel costs and to guarantee customers a consistently high quality standard promptly and reliably, even for global data traffic, a method for identifying industrial cables, comprising the following steps, is proposed: a. automatic visual identification of multiple different components of an industrial cable, from at least one image file; b. analysis of the geometric relationships and/or functional connections between the components; and c. extraction of individual characteristics of the components from the image file using information obtained in step b. A combination of the visual analysis with existing knowledge, also with the possible option of adding trained knowledge, allows an extremely reliably-functioning method for recognizing industrial cables to be provided.

### BACKGROUND

### Technical Field

The invention is based on a method for identifying industrial cables.

Cable manufacturers and cable providers require methods for identifying industrial cables in order to answer product-specific customer inquiries and consequently to also create suitable quotes for the respective customer where applicable. The customer inquiries usually relate to industrial cables already present with the customer and corresponding compatibilities. The customer typically already possesses one or a plurality of industrial cables. In this case, the same or alternative industrial cables with the same or similar functionality are usually to be found. For this purpose, the industrial cables can be allocated to predetermined functional categories. In this case, functional categories may be—by way of example but not limited to—one of the following: electrical energy transmission, electronic signal transmission (analog as well as digital), optical signal transmission, pneumatics, for example, air pressure transmission, and, in rare areas of application, the transfer of fluids, for example a cooling fluid.

### Description of the Related Art

In the prior art, it is normal for cable providers to receive, to analyze and to answer customer inquiries in the form of visual media, for example digital photos, image files, etc.

Inquiries of this type are presently answered manually and individually by the cable provider's experienced employees.

One disadvantage of this prior art is that these methods are costly and person-dependent and this sometimes results in undesirable waiting times for the customers, in particular in the case of international trade of goods and data traffic. If an employee of this type leaves the company of the cable provider, they must put their knowledge in writing and/or train a colleague, since otherwise the company may lose the relevant knowledge. The disadvantage for all parties involved is that this jeopardizes a consistently high quality standard of customer service.

### BRIEF SUMMARY

Embodiments of the invention involve presenting a method for identifying industrial cables which saves a cable provider personal costs and guarantees their customers a consistently high quality standard in a quick and reliable manner, even for global data traffic.

According to one embodiment, a method is used for the identification of industrial cables and includes the following steps:
a. automatic visual identification of a plurality of different components of at least one industrial cable from at least one image file;
b. analysis of the geometric relationships and/or functional connections between these components; and
c. extraction of individual features of the components from the image file using information obtained from step b.

This is particularly advantageous, since this method can be carried out automatically and without manual, i.e., human, intervention. Irrespective of the time of day and date, inquiries from all over the world can be processed competently and with a consistently high level of quality by a computer program which, for example, runs on a computer server in-house or also advantageously with little maintenance effort in a cloud application. For this purpose, the computer server can have at least one microprocessor and a combined program/data storage device. The method can be saved as part of the computer program in the data storage device.

In this case, it has proven to be particularly advantageous that method step c takes place using information obtained from step b. Finally, in this way, specialized knowledge regarding the functionality and the structure of industrial cables can be taken into account in the method. This knowledge, for example, relates to the current-carrying capacity, the temperature resistance, protection against moisture, weather, ozone, UV resistance as well as shielding and insulating properties and, consequently, material and strength of the insulation, the shielding, for example material and configuration of a shielding braid and in particular the cohesiveness of individual strands, shields and/or insulations with a common electrical conductor, etc.

The knowledge may have been introduced previously into the method, i.e., already before method step a, when creating the computer program by way of or with the support of a person skilled in the art. In a preferred configuration, the system can additionally also generate additional knowledge in a self-learning manner.

For example, the method can be carried out as follows: the image file consists of a cross-sectional representation of an industrial cable which, among other things, possesses a shielded twisted pair line. In method step a., the information is obtained that a twisted pair line surrounded by at least its own insulation is present. It can therefore be concluded in method step b. that the twisted pair line in all likelihood also possesses a shield, since empirically twisted pair lines which indeed have their own insulation but not their own shield only exist very rarely. This expertise may have been previously programmed into the system. Alternatively or additionally, however, this knowledge can be obtained from the method itself by self-learning algorithms over a sufficiently long period, i.e., via a sufficiently large number of different analyses.

In many cases, in particular if a plurality of such high probabilities are interconnected, it can be assumed that the facts are almost certain. In the method, one or a plurality of threshold values can be provided for this purpose for the corresponding probabilities.

However, alternatively or additionally, in method step a., it may have already been recognized that the twisted pair conductors are surrounded by any shield which is arranged inside the insulation, without the type of this shield having been able to be precisely identified in method step a.

However, said programmed knowledge from step b. makes it possible to further conclude in step c. that this shield must be a shielding foil, since—as known from step b—in principle only shielding foil is considered for shielded twisted pair lines. In other words: according to the programmed and/or self-learned knowledge which method step b falls back on, twisted pair lines which possess a shielding that does not consist of shielding foil are not known. Consequently, from the recognition of a shielded twisted pair line, it follows that the recognized shield must, in turn, consist of foil.

In one preferred configuration, at least some of the following component categories can be available for method step a:
lines;
strands;
outer shielding;
outer sheathing;
inner sheathing;
insulation; and
individual shieldings.

Moreover, relatively trivial, optically recognizable features such as color and labeling of the lines and/or the entire industrial cable can, of course, play a role in allocation.

More specifically, the lines of the industrial cables can further be characterized by at least one of the following features:
strength and shape of the respective electrical conductor/the respective line wire;
strength and shape of the conductor insulation; and
type and shape of the line shield.

For this purpose, method step a can advantageously comprise:

An automatic visual recognition of the components as individual objects as well as an allocation of the components to component categories of the industrial cable by artificial intelligence (AI).

In addition, an allocation of the recognized components to at least one functional category can optionally take place in method step a.

For enabling automatic identification, the system can be “taught” manually, i.e., through human activity, beforehand, i.e., already before method step a, in order to recognize and characterize the components. In this case, not only component categories such as, for example, “wires,” “strands,” “insulation,” “shielding,” “cable sheathing,” etc., are trained, but rather specific, internal as well as general type designations for a previously made selection of the components can also be allocated. These allocations take place according to those categories which the system has been taught previously when training its artificial intelligence (AI).

By way of the artificial intelligence (AI), the system learns beforehand from manually created training tables in conjunction with training images. Through this learning process, in aforementioned process step a, the system consequently has the ability, for newly added image files—or defined parts thereof—to independently allocate the components found therein to these component categories.

For this purpose, the aforementioned training is therefore firstly carried out manually temporally already before carrying out method step a.

In one simple example, a series of training images in each case contains a shielded twisted pair line with a twisted pair wire pair which is surrounded by a shield and a conductor insulation. The wire pair, its wires, its conductors and the insulation thereof as well as, if applicable, a shield and its sheathing are entered into the system by hand in the form of geometric data as coordinates. At this point, the AI should merely be considered as a “black box,” i.e., only in terms of its functionality. If the method is then applied to user data, i.e., for the analysis of an image file sent by the customer of an image of an industrial cable represented in cross section, the shield of the twisted pair line can, for example, if it can be clearly seen in the image, therefore already be recognized as such because it has a great similarity to the shields of the training images in position and composition.

Despite the fact that this training does initially require manual, i.e., human, effort, this is in principle only necessary once and the method can subsequently be used as often and as cost effectively as desired and at any time.

In this case, the training comprises the process of firstly importing a multiplicity of training images and manually allocating the respective component categories to the associated training images, for example by way of training tables.

In one preferred development, this allocation can occur by allocating a row in the training table to each training image per component. In the training table, in addition to the column for the referenced training image, there is moreover a column for the component category, as well as four columns which describe the precise position of the component in the image, for example in an x and y axis and/or, for example, by vectors and/or polar coordinates and the height and width thereof in a precise manner.

In one further example, a training image shows an industrial cable in cross section which has a specific high-current line. The high-current line possesses a designation, for example “Delta Power 03” and/or an internal item number, for example “10 47 003 2634.” The training table then possesses precisely one row for the combination training image component, in which, for example, the entry “Image4813” for the training image, an internal type designation for the respective component, and the position data, for example the numerical values “92, 25, 178, 75” for either the x-y positions or corresponding numerical values for polar coordinates, as well as height and width and/or center and radius of the component in cross section of the industrial cable can be found. Identifiers, relative position and dimension (height/width; center/radius or the ratios thereof with respect to the different components) may have been entered by hand previously by a person skilled in the art. In the case of using item numbers, it can be particularly advantageous if they are systematically maintained. Components which differ only slightly can therefore also possess item numbers which have a certain similarity to one another, for example they differ only in their last digit or several last digits. In this case, the training table can optionally also be provided with reduced item numbers or the AI can perform a rough allocation in any other manner, for example, by way of allocation to general terms.

In one further preferred configuration, an item number of a component can also be used as a substitute for similar components, in order to achieve a somewhat rougher rasterization and, as a result, a meaningful allocation. For example, different signal lines which differ only in the color of their insulation can, in this way, be allocated to a common component category, despite their minimal differences.

Within the context of the training, the AI preferably adjusts the weights of its neural connections over a multiplicity of training images in such a way that is has the ability to determine the component on the images including position and dimension. In this case, the AI has the ability to independently extract features (such as edges, textures, etc.) relevant for the determination and, in the same way, can therefore also identify unknown images even beyond the training which include the trained components. Of course, this principle can similarly also be applied to every other visual characteristic via a training table. In particular, a statistical evaluation is useful in this case in which the visual characteristics of each individual training image can be viewed as a so called “sample,” i.e., a random data selection from the totality of the features concerning the respective feature.

In method step a, all components known to the AI can subsequently be identified, allocated and localized (i.e., to a known category, such as “high-voltage line, for example) from each of the image files which derive from customer inquiries, for example.

However, alternatively or additionally, the objects can similarly also be allocated to specific construction forms. If the component category is therefore specially trained on very specific products, i.e., not merely in general, for example on a “high-current line” or “signal line,” but rather, as described in the above mentioned example, on internal item number “10 47 003 2634,” the objects which are to be analyzed are subsequently allocated to these component categories.

However, the training can alternatively or additionally also relate to specific, known features of the respective components.

As has been shown in numerous trials and test runs, this principle also sometimes functions very well for features in the case of which a person skilled in the art of cables would not initially expect it. For example, the AI can, among other things, also be trained with regard to material and/or manufacturing method. This is then usefully done with training images which correspond to the manufacturing methods and materials which occur in the respective sector. For this purpose, the objects shown on the training images can, in fact, but do not necessarily have to show components which originate from the cable sector. In fact, they only have to have the corresponding manufacturing-specific and material-specific characteristics which should be important in the respective examination, for example “plastic,” “metal,” “strand,” “braid” and/or “foil.” However, the AI can alternatively also be done exclusively with training images of components from the cable manufacturing sector and in particular precisely with the relevant components, for example “cable sheathing,” wherein, however, the focus of the features is then on the material and the manufacturing methods. More specifically, the training can be empirically adapted to the respective learning success which is to be manually checked.

As a result, it is also possible, in a very special configuration, for example, to subsequently also allocate objects identified as “energy line wires” to the respective material and/or manufacturing method in a first step, and thus to make a preselection from which a final product-specific allocation takes place in a third step.

The aforementioned method makes is possible to identify components shown on one image or in a plurality of images, for example “stranded conductors,” “insulation,” “shielding,” “cable sheathing,” etc.

These components, for example the insulations, can be classified by geometric properties such as strength and shape, but they can further also be classified functionally by the aforementioned programming, for example in temperature resistance, flexibility, electrical creep properties. Alternatively or additionally, they can be allocated according to material and manufacturing method, but they can also be allocated according to specific products, for example.

Moreover, the industrial cable can be characterized by one or a plurality of the following features:
outer diameter;
presence and, if applicable, type of an outer shield;
number of lines;
strength of its wires;
material and/or manufacturing method of the wires;
strength, shape and/or position of the individual insulations of the wires;
material and/or manufacturing method of these insulations;
presence and, if applicable, type and shape of individual shieldings and/or a separate PE (protective earth) line;
strength and shape of the cable sheathing, as well as their suitability for a specific cable gland,
   wherein it is clear to the person skilled in the art that the features which relate to dimensions can advantageously be considered in their relative size to one another.

In one further preferred configuration, the individual lines can be characterized by at least one of the following features:
their size and geometric shape;
at least one functional category; and
their geometric arrangement in the cable,
   wherein it is clear to the person skilled in the art that the features which relate to dimensions can advantageously be considered in their relative size to one another.

The functional category can comprise at least one of the following features:
electrical energy transmission,
analog and/or digital electronic signal transmission,
optical as well as optoelectronic signal transmission, and
pneumatics, for example, air pressure transmission.

The following component categories can additionally also be available for method step a:
strands,
insulations, and
shieldings.

The strands can further be characterized by at least one of the following features:
their geometric dimensions;
their functional category; and
their position in the cable, i.e., in the cable cross section,
   wherein it is clear to the person skilled in the art that the features which relate to dimensions can advantageously be considered in their relative size to one another.

In this case, the functional category can be formed by one of the following features:
electrical energy transmission;
analog and/or digital electronic signal transmission;
optical as well as optoelectronic signal transmission;
pneumatics, for example air pressure transmission; and
data transmission.

In particular, the method can combine an artificial intelligence (AI)-based automatic visual recognition (typically by way of “convolutional neural networks” (CNNs)) with subsequent algorithmic image processing in the aforementioned manner.

The learning process and the analysis of individual components can advantageously take place taking into account the physical structure of other components of the industrial cable. Starting from a digital image of a cable cross section, the components of the industrial cable can be identified precisely by way of the proposed process and in particular can be described geometrically according to their functional relationship to one another. A hierarchical description of an industrial cable is made possible by the advantageous sequential processing chain of cable identification and algorithmic analysis.

In this case, it is particularly advantageous that qualitative allocations and comparisons are possible which could not be reflected in the prior art with a previously automatic recognition. The method according to the invention is characterized in particular by the combination of an AI-based automatic visual recognition, for example, by way of “convolutional neural networks” (CNNs), and the subsequent algorithmic image processing, namely, taking into account the physical structure of an industrial cable, i.e., the functional and geometric relationship to one another.

### BRIEF DESCRIPTION OF THE SEVERAL VIEWS OF THE DRAWINGS

A preferred exemplary embodiment of the invention is represented hereinafter using drawings and is explained in greater detail hereinafter. For this purpose, a system for identifying an industrial cable 100 from a digital image file is presented. In the drawings:

FIG. 1 shows an image which is to be analyzed of an industrial cable which is to be identified;

FIG. 2 shows a flow diagram of a method for identifying the components of the industrial cable from a digital image file which belongs to the image.

The figures may contain partially simplified, schematic representations. Identical reference numbers are used in part for the same but possibly not identical elements. Different views of the same elements may be scaled differently.

### DETAILED DESCRIPTION

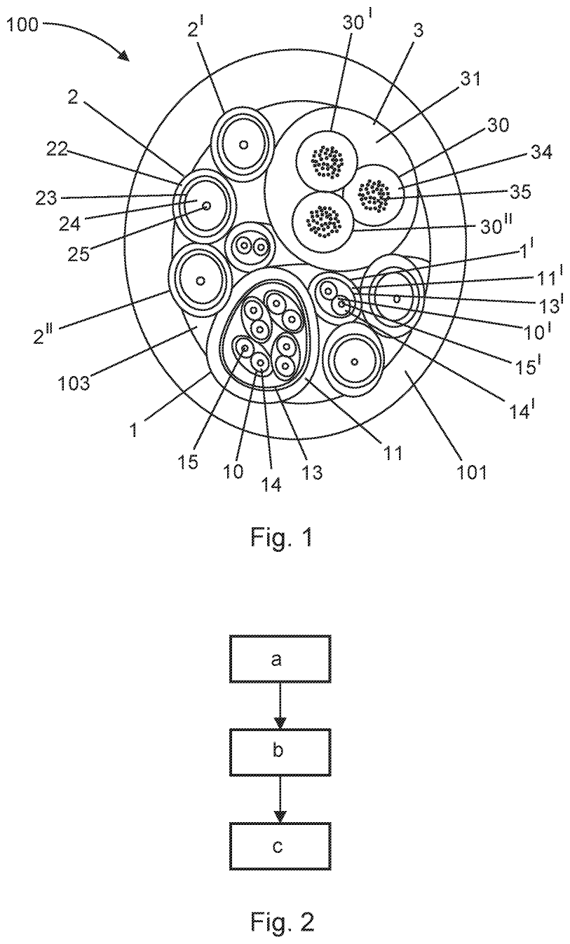

FIG. 1 shows an image which is to be analyzed of an industrial cable 100 which is to be identified. This image is the content of an image file sent by the customer. The image shows a cable cross section with an outer cable sheathing 101 and a shielding 103 embedded therein in the form of a shielding braid which is not graphically represented in the drawing for reasons of clarity. The following components are arranged inside this cable sheathing 101:
a quadruple twisted pair line 1 with four individual twisted pair lines;
two separate single twisted pair lines 1′;
five individual coaxial lines 2, 2′, 2″;
one energy line 3 with three energy line wires 30, 30′, 30″.

In this case and hereinafter, the same, i.e., principally repeating components, are not always provided with their own reference number for the sake of clarity.

This rough list alone is already suitable for fundamentally characterizing the industrial cable 100 and for mentally connecting it with functionally comparable other industrial cables.

For more precise allocation to their respective component categories, the components already specified are, in turn, explained in greater detail by way of further components and their individual composition.

Of the two separate single twisted pair lines 1′, only one, representative of the other, is explicitly provided with a reference number. In the case of these separate single twisted pair lines, each twisted pair wire pair consists of two wires 10′, which, in turn, are formed from a twisted pair conductor 15′ and a conductor insulation 14′ surrounding it in each case. The wire pair possesses a twisted pair sheathing 11′ as its own sheath with a twisted pair shielding foil 13′ arranged on the inside of it which is not represented in the drawing for reasons of clarity.

The quadruple twisted pair line 1 possesses, as already mentioned, the four individual twisted pair lines which, in turn, each have two twisted pair wires 10. Each of these wires 10 is formed from a twisted pair conductor 15 and a conductor insulation 14 surrounding it. In this case, the two twisted pair wires 10 together form a twisted pair wire pair in each case. Each twisted pair wire pair is surrounded by its own wire pair sheathing and a shielding foil located inside it, wherein this wire pair sheathing and the shielding foil located inside it belong to the respective twisted pair line and are in fact not provided with a reference number here for reasons of clarity. The four twisted pair lines are together surrounded by a twisted pair sheathing 11 and by a common shielding foil 13 located inside it.

Only three of the five coaxial lines 2, 2′, 2″ are provided with at least one reference number at all for reasons of clarity. One of these coaxial lines is fully designated as representative of the others. It possesses an electrical inner conductor 25, surrounded by a coaxial insulation 24. This, in turn, is surrounded by an inner shield 23 which, in turn, is surrounded by a coaxial line sheathing 22.

Moreover, the industrial cable 100 possesses an energy line 3 with three energy line wires 30, 30′, 30″. In the aforementioned manner, here too only one energy line wire 30 is fully designated here. The energy line wires 30, 30′, 30″ each possess an energy line strand 35 as an electrical conductor which is surrounded by a wire insulation 34 in each case. These three energy line wires 30, 30′, 30″ are together surrounded by an energy line sheathing 31 which is also a component of the energy line 3.

FIG. 2 shows a flow diagram of a method for exemplary automatic identification of the industrial cable 100 from this image file.

The method is carried out by way of a computer program on a computer server, and comprises the following steps:
a. automatic identification of the basic components 10, 10′, 2, 2′, 2″, 30, 30′, 30″ of the industrial cable 100 from the image file through automatic visual recognition and allocation of the basic components 10,10′, 2, 2′, 2″, 30, 30′, 30″ as individual objects by way of artificial intelligence (AI);
b. analysis of the geometric relationships and/or functional connections between the individual components 10, 10′, 2, 2′, 2″, 30, 30′, 30″;
c. extraction of individual features of the basic components 10, 10′, 2, 2′, 2″, 30, 30′, 30″ from the image file using information obtained from step b.

In method step a, the following components are firstly separated from one another by way of a so called “convolutional neural network” (CNN), i.e., recognized as different objects and allocated to the different component categories.

In method step a, owing to a training preceding the method, the system therefore recognizes, for example, the following:
a first object 101 of the category “cable sheathing”;
a second object 1 of the category “quadruple twisted pair line”;
two third objects 10′ of the category “single twisted pair line”;
five fourth objects 2, 2′, 2″ of the category “coaxial line”;
a fifth object 3 of the category “energy line.”

However, the objects can in this case—depending on the type of previous training—also be allocated to specific, company-internal or public products, namely, their product designations and/or item numbers.

In method step b, the program firstly recognizes the geometric relationships, namely that the cable sheathing 101 surrounds the other objects. By way of its programmed knowledge, the program concludes that further insulations and strands, as well as further shieldings, if applicable, are located inside the identified cable sheathing 101, even if they have not been optically recognized.

In method step c, further individual features of the components 10, 10′, 2, 2′, 2″, 30, 30′, 30″ are identified. This includes, for example, the allocation of the energy line 3 and the associated energy lines 30, 30′, 30″ for electrical energy transmission.

Following the same principles, further visual/geometric features can be derived according to their hierarchy. In this case, the algorithmic image processing incorporates particular physical features, such as repeated arrangements as well as the size ratios of the components, for example.

The method can, for example, be carried out as follows:

The image file of the image shown in FIG. 1 consists of a cross sectional representation of the industrial cable 100 which possesses the third object, namely the shielded single twisted pair line 1′. In method step a., the information that a twisted pair line 1′ surrounded by its own sheath is present is firstly obtained for this purpose. It can therefore be concluded in method step b that the single twisted pair line 1′ in all likelihood also possesses a shield 13′, since empirically—and this knowledge is finally programmed into the system—twisted pair lines with insulation but without a shield only exist very rarely. In one further design, such knowledge can also be generated by the system self-learning from its own experience.

However, in method step a., for example in the case of the quadruple twisted pair line 1, the visual analysis may also have already recognized that the twisted pair conductors 1 are surrounded by any twisted pair shield 13 which is arranged inside the twisted pair sheathing 11, but without the type of this twisted pair shield 13 being able to be precisely identified in method step a.

This information obtained from step b makes it possible to conclude in both cases in step c that one of each twisted pair shields 13, 13′ exists and that it must be a shielding foil, since in principle only shielding foil is considered for shielded twisted pair lines 1, 1′.

A very reliably functioning system for recognizing industrial cables is thus provided by the combination of existing knowledge, and optionally also possibly additionally supplemented by learned knowledge, in conjunction with the visual analysis.

It is clear to the person skilled in the art—unless otherwise specified—that the combinations represented and discussed are not the only possible combinations, even if different aspects or features of the invention are in each case shown in combination in the figures. In particular, mutually corresponding units or feature complexes from different exemplary embodiments can be exchanged with one another.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method for identifying industrial cables, comprising:
automatically visually identifying a plurality of different components of at least one industrial cable from at least one image file;
analyzing geometric relationships and/or functional connections between the plurality of different components; and
extracting individual features of the plurality of different components from the image file using information obtained from the analyzing of the geometric relationships and/or functional connections between the plurality of different components.

2. The method as claimed in claim 1, wherein automatically visually identifying the plurality of different components of the at least one industrial cable from at least one image file comprises at least the automatic visual recognition of the components as individual objects and the allocation of the components to component categories by artificial intelligence.

3. The method as claimed in claim 2, wherein at least the following component categories are available for the allocation of the components to the component categories:
lines;
outer shielding; and
cable sheathing.

4. The method as claimed in claim 3, wherein the lines are further comprised of one or a plurality of the following features:
strength and shape of at least one line wire with an electrical conductor and a conductor insulation surrounding the electrical conductor;
strength and shape of the conductor insulation; and
type and shape of a line shield.

5. The method as claimed in claim 3, wherein the industrial cable is further comprised of one or a plurality of the following features:
outer diameter;
presence and type of an outer shield;
number of lines;
strength of their wires of the lines;
material and/or manufacturing method of the wires;
strength, shape and/or position of the individual insulations of the wires;
material and/or manufacturing method of the insulations;
presence and type and shape of individual shieldings and/or a separate protective earth (PE) line;
strength and shape of the cable sheathing; and
suitability of the cable sheathing for one or a plurality of specific cable glands.

6. The method as claimed in claim 3, wherein the lines are further comprised of at least one of the following features:
size and geometric shape of the lines;
at least one functional category; and
geometric arrangement of the lines in the industrial cable.

7. The method as claimed in claim 6, wherein the functional category comprises at least one of the following features:
electrical energy transmission;
analog and/or digital electronic signal transmission;
optical and optoelectronic signal transmission; and
pneumatics.

8. The method as claimed in claim 3, wherein the following component categories are additionally available for the allocation of the components to the component categories:
electrical conductors/strands;
insulations; and
shieldings.

9. The method as claimed in claim 8, wherein the lines of the industrial cable are further comprised of at least one of the following features:
geometric dimensions of the lines; and
functional category of the lines.

10. The method as claimed in claim 9, wherein at least one of the components is additionally allocated to at least one of the following functional categories:
electrical energy transmission;
analog and/or digital electronic signal transmission;
optical and optoelectronic signal transmission; and
pneumatics.

11. The method as claimed in claim 2, wherein item numbers are used as component categories.

12. The method as claimed in claim 2, wherein product designations are used as component categories.
